(19) United States
(12) Patent Application Publication
(10) Pub. No.: US 2009/0030808 A1
(43) Pub. Date: Jan. 29, 2009

(54) CUSTOMIZED TOY PET

(76) Inventor: Shinyoung Park, Palisades Park, NJ (US)

Correspondence Address: Frank Chau, Esq.;F. CHAU & ASSOCIATES, LLC, 130 Woodbury Road, Woodbury, NY, 11797, US

(21) Appl. No.: 12/058,229

(22) Filed: Mar. 28, 2008

Related U.S. Application Data
(60) Provisional application No. 60/952,038, filed on Jul. 26, 2007.

(51) Int. Cl. G06Q 30/00; A63H 3/28

(52) U.S. Cl. 705/26; 446/297

(57) ABSTRACT

A method of transmitting a virtual item and a physical item to a receiver includes customizing a virtual item in a designated internet website, producing a physical item corresponding to the customized virtual item, designating a receiver of the virtual item, designating the receiver of the physical item, transmitting the customized virtual item to the designated receiver, and transmitting the physical item to the designated receiver, wherein the physical item has a same three-dimensional appearance with the virtual item displayed on a two-dimensional screen of the designated internet website.

### CROSS-REFERENCE TO RELATED APPLICATION

This application claims priority to provisional application Ser. No. 60/952,038, filed on Jul. 26, 2007, the disclosure of which is incorporated herein by reference in its entirety.

### TECHNICAL FIELD

The present disclosure relates to a toy pet, and more particularly to a method of transmitting a virtual toy pet and a physical toy pet to a receiver.

### DISCUSSION OF RELATED ART

Many toy pets are difficult to be customized by a user. For example, Furby™ is a toy pet expressing emotions and can understand user's commands. However, Furby is difficult to be customized. Nabaztag™ is another type of a toy pet delivering information along with messages among family members. However, it is also difficult to customize Nabaztag as the user desires.

In internet social networking web sites, users send messages and pictures to communicate with their friends and families. A user can communicate her emotions better with a friend if the friend can receive a customized virtual toy pet from the internet social networking sites and can receive a customized physical toy pet, looking and behaving like the virtual toy pet, from her mail box at home.

### SUMMARY OF THE INVENTION

According to exemplary embodiments of the present invention, users can carry a toy pet anywhere they go and the toy pet can be attached to clothes for decoration. The color, size, personality and functions of the toy pet can be customized on the internet by a user or at the point of purchasing from a store so that each user or customer can possess a unique toy pet. The toy pet can be small enough to carry around, and the toy pet can be customized on the internet or at the point of purchasing from a store so that users can express their uniqueness through the toy pet. The size of toy pet is not limited. The toy pet can be a fashion item. The toy pet can provide comfort, relaxation, and useful information to the users.

According to an exemplary embodiment of the present invention, a method of transmitting a virtual item and a physical item to a receiver comprises customizing a virtual item in a designated internet website, producing a physical item corresponding to the customized virtual item, designating a receiver of the virtual item, designating the receiver of the physical item, transmitting the customized virtual item to the designated receiver, and transmitting the physical item to the designated receiver, wherein the physical item has a same three-dimensional appearance with the virtual item displayed on a two-dimensional screen of the designated internet website.

Customizing the virtual item may comprise inputting a voice message to the virtual item.

The physical item may have the same voice message with the voice message stored in the virtual item.

Customizing the virtual item may comprise at least one of selecting a color of the virtual item, selecting a face expression of the virtual item, and selecting a predetermined sound of the virtual item.

Customizing the virtual item may further comprise changing a frequency of generation of the predetermined sound of the virtual item.

Inputting the voice message to the virtual item may comprise recording the voice message of a user. Inputting the voice message to the virtual item may comprise typing a text message into the designated website, and converting the text message into the voice message.

The predetermined sound can be at least one of flatulence, yelling, laughing, yawning, sighing and giggling.

Producing the physical item corresponding to the virtual item can be performed with a generation of the virtual item.

Designating the receiver of the virtual item may comprise designating an email address of the receiver. Designating the receiver of the virtual item may comprise designating an HTTP (Hyper Text Transfer Protocol) server of the receiver.

Designating the receiver of the physical item may comprise designating a home or an office address of the receiver.

Transmitting the selected virtual item may comprise transmitting the customized virtual item through an internet protocol.

Transmitting the produced physical item to the designated receiver may comprise delivering the produced physical item in person to the home or office address of the receiver.

The virtual item can be displayed as an internet icon. The physical item can be at least one of a toy, a computer mouse, a speaker, a flash memory stick, a key chain, an MP3 player, a cell phone and a necklace.

The voice message of the virtual item can be played by clicking the icon. The voice message stored in the physical item can be played by touching the physical item, squeezing the physical item, or pressing a button disposed on the physical item.

The predetermined sound can be played randomly.

According to an exemplary embodiment of the present invention, an electronic circuit for use in a pet toy comprises a sensing circuit including a capacitor and a foil electrode, the foil electrode sensing an increase of electronic charges and the capacitor transmitting a first signal to a microprocessor based on the increased electronic charges, a main circuit including the microprocessor and a memory unit storing data for use in the microprocessor, the microprocessor producing a second signal to generate a sound and a third signal to generate a vibration, when the electric charge value is above a certain level and remains constant for a pre-determined time, the microprocessor sends the second signal to a sound generating circuit to play sounds, a sound generating circuit including a speaker, the sound generating circuit receiving the second signal from the microprocessor for generating the sound through the speaker, and a motion generating circuit including a vibrating motor, the motion generating circuit receiving the third signal from the microprocessor for generating the vibration, wherein the second signal is sent to the sound generating circuit from the microprocessor to play a sound played with a probability of 1/N through the speaker, wherein the N refers to the number of sounds.

The sound may include at least one of a sound of comfort, a news report, stock information, a weather report and fashion trend information.

The sound may include at least one of sighing, flatulence, yawning, giggling, and laughing.

The electronic circuit may further comprise a data receiving circuit including at least one of a USB connector, a Wi-Fi connection, and a Bluetooth connection.

The sound generating circuit may further comprise a next track, a previous track and a play/pause switch.

The microprocessor can send the second signal to the next track or the previous track to play different sounds each time when a random time is reached.

The electronic circuit can be disposed inside a body of the pet toy.

The foil electrode can sense the increase of the electric charges when the body of the pet toy receives an external impact.

A light emitting diode (LED) can be disposed on an outer surface of the body of the pet toy. The light emitting diode (LED) can emit light when the pet toy is turned on and can blink when the pet plays a sound.

According to an exemplary embodiment of the present invention, a method of generating a sound or a vibration for use in a toy pet comprises inputting a voice message into the toy pet, sensing a touch from a user of the toy pet, determining a value of electronic charges increased by the touch of the user, generating a first sound when the value of the electric charges is above a pre-determined level and remains constant for a pre-determined time, and generating a second sound or vibration when the toy pet is not touched by a user and when a random time is reached.

The first sound and the second sound can be played with a probability of 1/N, wherein the N refers to the number of sounds.

### BRIEF DESCRIPTION OF DRAWINGS

Exemplary embodiments of the present invention can be understood in more detail from the following descriptions taken in conjunction with the accompanying drawings, of which:

FIG. 1 is a cross-sectional bottom view of a toy pet according to an exemplary embodiment of the present invention;

FIG. 2 is a flowchart showing a method of generating a sound or a vibration for a toy pet according to an exemplary embodiment of the present invention;

FIGS. 3(a) and 3(b) are block diagrams showing a touch function and a random function of the toy pet, respectively, according to an exemplary embodiment of the present invention;

FIG. 4 is a schematic circuit diagram of an electronic circuit board and components connected to the electronic circuit board of a toy pet according to an exemplary embodiment of the present invention; and

FIG. 5 is a diagram showing a method of transmitting a virtual toy pet and a physical toy pet to a receiver according to an exemplary embodiment of the present invention.

### DETAILED DESCRIPTION OF EXEMPLARY EMBODIMENTS

Exemplary embodiments of the present invention will now be described more fully hereinafter below in more detail with reference to the accompanying drawings. This invention may, however, be embodied in different forms and should not be construed as limited to the embodiments set forth herein.

A toy pet according to an exemplary embodiment of the present invention can generate sounds, vibrations and/or lights.

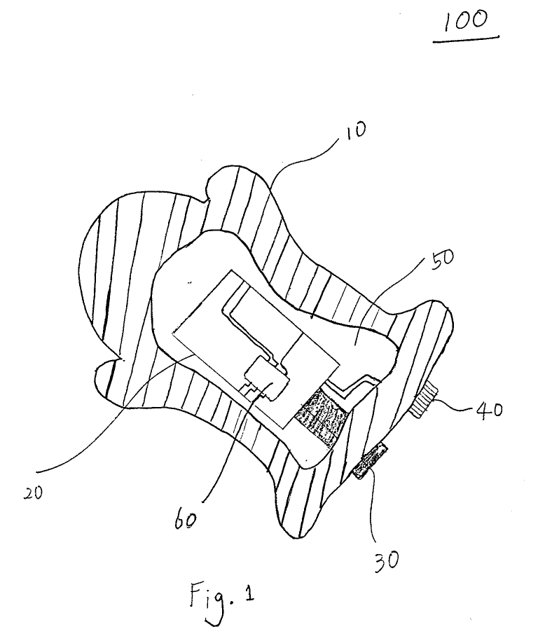

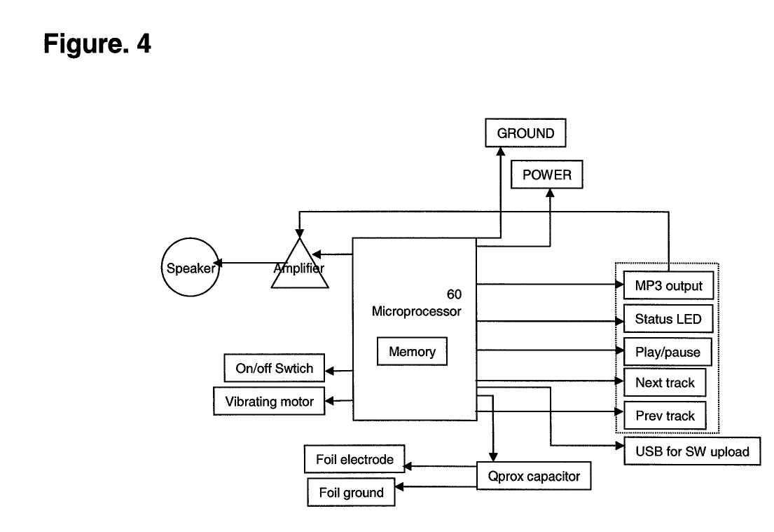

FIG. 1 is a cross-sectional bottom view of a toy pet 100 according to an exemplary embodiment of the present invention. The toy pet 100 includes, for example, a body 10, an electronic circuit board 20 including a microprocessor 60, a universal serial bus (USB) connector 30, and an ON/OFF switch 40. The body 10 can have a cavity 50 to receive the electronic circuit board 20 therein. A light emitting diode (LED) connected to the electronic circuit board 20 can be attached to, for example, a surface of the body 10. The light emitting diode (LED) can emit light when the toy pet 100 is turned on and can blink when the toy pet 100 plays a sound. A foil electrode (see, FIG. 4) connected to the electronic circuit board 20 can be formed in the body 10. A speaker can be formed on the electronic circuit board 20. Alternatively, the speaker can be connected to the electronic circuit board 20, thereby being located anywhere in the body 10. To propagate the sound from the speaker more effectively, the body 10 can contain, for example, perforations. However, the shape of the toy pet 100 is not limited.

An electronic circuit board 20 for use in the toy pet 100 comprises a sensing circuit, a main circuit, a sound generating circuit, and a motion generating circuit. The electronic circuit board is disposed inside the body 10 of the toy pet 100. The sensing circuit includes a capacitor and a foil electrode. The foil electrode senses an increase of electronic charges and the capacitor transmits a first signal to a microprocessor based on the increased electronic charges. The foil electrode senses the increase of the electric charges when the body 10 of the toy pet 100 receives an external impact.

Referring to FIGS. 1 and 4, the main circuit includes the microprocessor 60 and a memory unit. The memory unit stores data for use in the microprocessor 60. The microprocessor 60 produces a second signal to generate a sound and a third signal to generate a vibration, when the electric charge value is above a certain level and remains constant for a predetermined time. The microprocessor 60 sends the second signal to a sound generating circuit to play sounds. The sound includes at least one of a sound of comfort, a news report, stock information, a weather report and fashion trend information. Alternatively, the sound includes at least one of sighing, flatulence, yawning, giggling, and laughing. The sound generating circuit includes a speaker. The sound generating circuit receives the second signal from the microprocessor for generating the sound through the speaker. The sound generating circuit further comprises a next track, a previous track and a play/pause switch. The microprocessor 60 sends the second signal to the next track or the previous track to play different sounds each time when a random time is reached.

The motion generating circuit includes a vibrating motor. The motion generating circuit receives the third signal from the microprocessor 60 for generating the vibration. The second signal is sent to the sound generating circuit from the microprocessor to play a sound played with a probability of 1/N through the speaker. The N refers to the number of sounds.

The electronic circuit further comprises a data receiving circuit including at least one of a USB connector, a Wi-Fi connection, and a Bluetooth connection.

In an exemplary embodiment, when the toy pet 100 senses an outside force, the toy pet 100 generates a designated sound using a sensor such as a Qprox capacitor in the electronic circuit board 20 and the speaker in or connected to the electronic circuit board 20. The outside force can be, for example, a touching, a petting, a rubbing or a speaking by the user. The toy pet 100 can generate a sound when sensing a touch by the user. For example, when touched more than about 3 seconds, the pet 100 generates a designated sound. The designated sound can be, for example, a sound of comfort, news, stock information, or weather information. The sound of comfort can be a sentence such as, for example, “don't worry”, “you're awesome” or “you're beautiful”.

In an exemplary embodiment, the toy pet 100 can generate sounds randomly without sensing an outside force. The sounds can be, for example, sighing, flatulence, yawning, giggling or laughing. In an exemplary embodiment, the toy pet 100 can generate vibrations or lights either randomly or when an outside force is sensed. In an exemplary embodiment of the present invention, the toy pet 100 can be used as a memory card for a user to save data such as documents, pictures, movies or songs. The toy pet 100 can be attached to clothes or backpacks. The toy pet 100 can be used as any accessory such as, for example, a key chain or a cell phone cover.

In an exemplary embodiment, the toy pet 100 can recognize each other through, for example, Bluetooth or RFID tag. There can be pre-defined groups of the toy pet 100 so that different groups of the toy pet 100 can have different personalities. When more than one toy pet 100 can recognize each other within a predetermined distance, the toy pets 100 can respond to each other. For instance, the toy pets 100 can say “Hi” to each other when they are recognized as friends. Alternatively, the toy pets 100 can growl at each other when they are enemies. Various relationships and responding methods can be defined according to personalities of the toy pets 100. These personalities or stories can be programmed to the toy pets 100 so that new relationships between the pets 100 can be created or changed. For instance, the relationships and stories can be updated through internet websites, thereby changing the personalities and/or relationships between the toy pets 100.

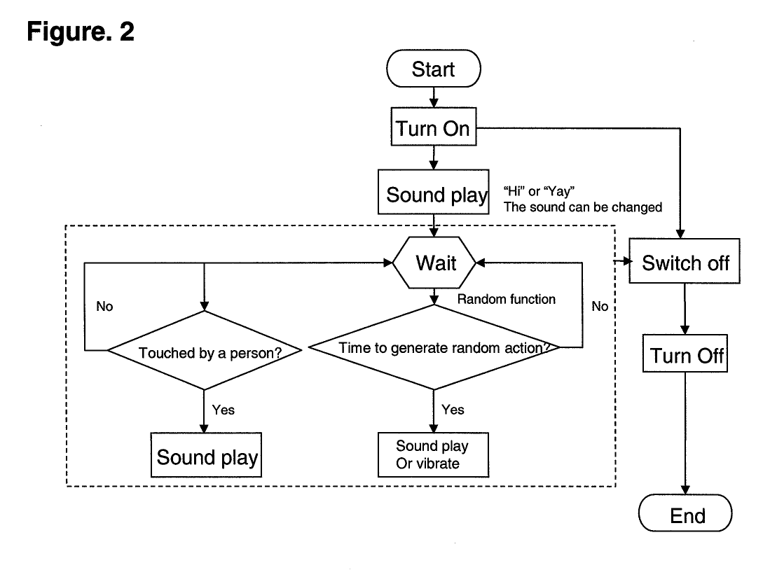

FIG. 2 is a flowchart showing a method of generating a sound or a vibration for the toy pet 100 according to an exemplary embodiment of the present invention. Referring to FIG. 2, when the toy pet 100 is turned on by the switch 40, the toy pet 100 generates a sound such as, for example, “Hi” or “Yay”. Alternatively, this step can be omitted. When the toy pet 100 is touched by a user, a designated or programmed sound can be generated. When time reaches to a predetermined point to generate a random function, a sound or a vibration can be generated.

In an exemplary embodiment of the present invention, a method of generating a sound or a vibration for use in the toy pet 100 comprises inputting a voice message into the toy pet 100, sensing a touch from a user of the toy pet 100, determining a value of electronic charges increased by the touch of the user, generating a first sound when the value of the electric charges is above a pre-determined level and remains constant for a predetermined time, and generating a second sound or vibration when the toy pet 100 is not touched by a user and when a random time is reached. The first sound and the second sound are played with a probability of 1/N, wherein the N refers to number of sounds.

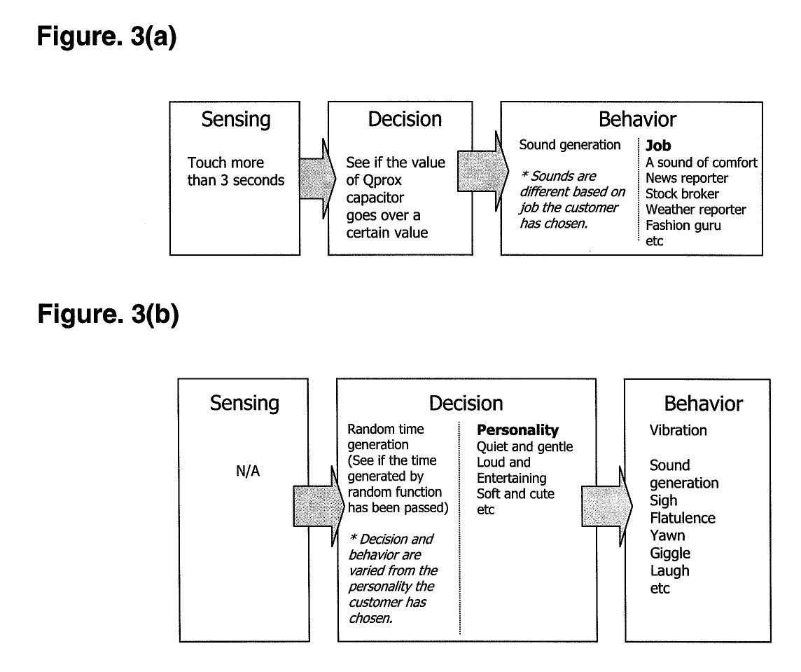

FIGS. 3(a) and 3(b) are block diagrams showing a touch function and a random function of the toy pet 100, respectively, according to an exemplary embodiment of the present invention. Referring to FIG. 3(a), the toy pet 100 can sense an outside force when the user touches the toy pet 100 for more than, for example, about 3 seconds. If a value of the Qprox capacitor (see FIG. 4) is over a predetermined value, a sound can be generated. The sound can be programmed before selling or can be programmed by the user after purchasing the toy pet 100. Referring to FIG. 3(b), if a predetermined time for the random function is passed, a vibration or a sound can be generated.

The sounds, vibrations or lights according to an exemplary embodiment of the present invention can be programmed by the user. For instance, to download or delete the designated sound, a user can connect the toy pet 100 to a programming device such as, for example, a computer via, for example, the USB connector 30. Also, any wireless communication methods can be used to connect the toy pet 100 to the computer, a server, or a cell phone. When the toy pet 100 is connected to a computer, the user can access a specific website or a specific application in the computer to download or delete the designated sound. In an exemplary embodiment, a new program can be downloaded to the toy pet 100 by clicking a download button on the website or the application. For instance, once stock information is downloaded to the toy pet 100, the stock information can be heard by touching the toy pet 100 for more than about 3 seconds. For instance, once weather information is programmed on the toy pet 100, the weather information can be heard by saying “how is the weather today?” to the toy pet 100. By programming the toy pet 100, the user can make the toy pet 100 to have a unique character. The unique character can be, for example, shyness, quietness, calmness, sweetness, joy or entertaining. One toy pet 100 can have at least one unique character. The unique character can be programmed based upon, for example, the mood of the user.

FIG. 4 is a schematic circuit diagram of the electronic circuit board 20 and components connected to the electronic circuit board 20 of the toy pet 100 according to an exemplary embodiment of the present invention.

Referring to FIG. 4, the microprocessor 60 may include a memory unit for storing data, which can be accessible by the user. Alternatively, the memory unit can be formed separately from the microprocessor 60. A time to generate a random sound or a vibration is pre-determined by the microprocessor 60. When a pre-determined time is reached, the microprocessor 60 turns on either a vibrating motor or a play/pause switch by the probability of, for example, 50:50. More than one random sound can be stored, changed and deleted in the microprocessor 60 or any kind of data storage. When the play/pause switch is on, a signal or data is sent to an MP3 output from the microprocessor 60, and one of the sounds is played with a probability of 1/N (N: number of sounds) through the amplifier and the speaker. To play different sounds each time when a random time is reached, the microprocessor 60 sends a signal or data to a next track or a previous (prev) track. Then, the play/pause switch can be turned off, for example, in two seconds.

When a user touches the body 10 of the toy pet 100, the foil electrode formed in the body 10 senses an electric charge. An electric charge value goes up when the body 10 is touched. When the electric charge value is above a certain level and remains constant for a pre-determined time, for example, about three seconds, the microprocessor 60 turns on the play/pause switch to play sounds. More than one sound can be stored, changed and deleted in the microprocessor 60 or any kind of data storage. When the play/pause switch is on, a signal or data is sent to the MP3 output from the microprocessor 60, and one of the sounds can be played with the probability of 1/N (N: number of sounds) through the amplifier and the speaker. To play different sounds each time when the body 10 is touched, the microprocessor 60 sends a signal or data to a next track or a previous (prev) track. Then, the play/pause switch can be turned off in, for example, two seconds.

In an exemplary embodiment of the present invention, the light emitting diode (LED) can emit light when the toy pet 100 is turned on. The LED may blink when the toy pet 100 plays a sound.

In an exemplary embodiment of the present invention, random sounds and touch sounds can be stored under different file names. For example, a file name of a random sound can be random_{—}0#, and a file name of a touch sound can be touch_{—}1#. Thus, the microprocessor 60 can play sounds having different file names.

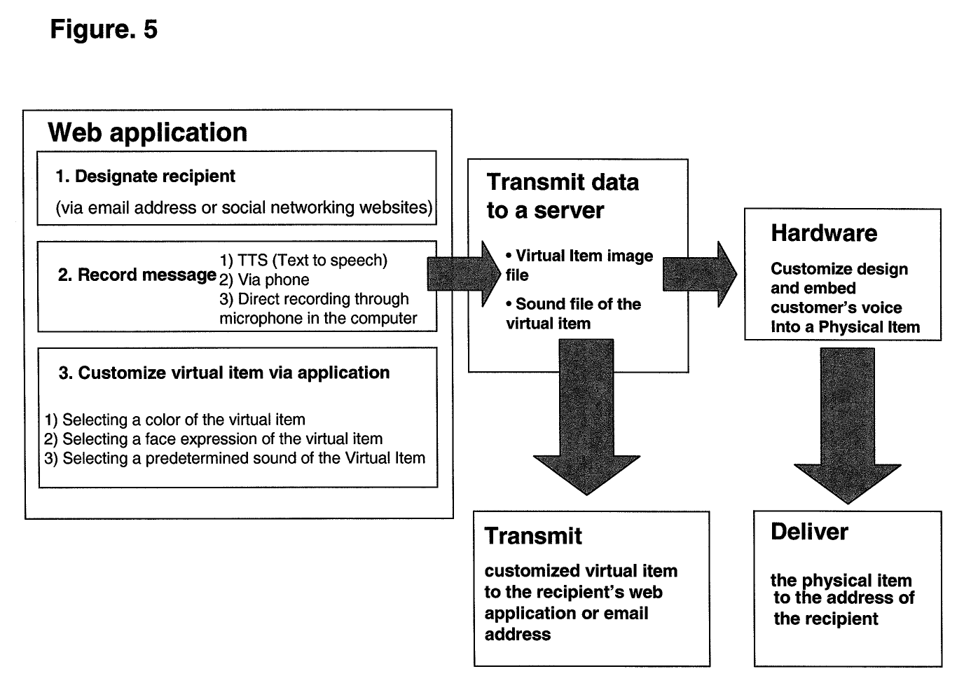

FIG. 5 is a diagram showing a method of transmitting a virtual item and a corresponding physical item (e.g., the toy pet 100) to a receiver according to an exemplary embodiment of the present invention.

The method comprises customizing a virtual item using a web application in a designated internet website. The virtual item can be displayed, for example, as an internet icon. The designated internet website can be, for example, a social networking website. In an exemplary embodiment, customizing the virtual item comprises inputting a voice message to the virtual item. Inputting the voice message to the virtual item comprises recording the voice message of a user. Inputting the voice message of the virtual item comprises typing a text message into the designated website, and converting the text message into the voice message. The voice message also can be recorded via telephone or cellular phone. Alternatively, a user can directly record the user's voice through a microphone attached to the computer. The voice message of the virtual item can be played by clicking the icon shape virtual item displayed on the computer screen.

Customizing the virtual item comprises at least one of selecting a color of the virtual item, selecting a face expression of the virtual item, and selecting a predetermined sound of the virtual item. The predetermined sound can be at least one of flatulence, yelling, laughing, yawning, sighing and giggling. The predetermined sound can be played randomly. Customizing the virtual item further comprises changing a frequency of a generation of the predetermined sound of the virtual item. The user can change the pitch and/or the speed of the voice message.

A physical item such as the toy pet 100 corresponding to the customized virtual item can be produced such that the physical item has the same appearance as the customized virtual item and includes the same voice message as the customized virtual item. The physical item can be at least one of a toy, a computer mouse, a speaker, a flash memory stick, a key chain, an MP3 player, a cell phone and a necklace. The physical item has a same appearance with the virtual item. For example, the physical item has a same three-dimensional appearance with the virtual item displayed on a two-dimensional screen of the designated internet website. The physical item has the same voice message with the voice message stored in the virtual item. The voice message stored in the physical item can be played by touching the physical item, squeezing the physical item, or pressing a button disposed on the physical item. Producing the physical item corresponding to the virtual item can be performed substantially simultaneously with a generation of the virtual item. Alternatively, the physical item can be manufactured after the virtual item is electrically delivered to the receiver.

A receiver of the virtual item can be designated before or after the virtual item is customized on the web application. The virtual and physical item receiver can be, for example, a social networking website user. Designating the receiver of the virtual item comprises designating an HTTP server of the receiver or designating an email address of the receiver. The customized virtual item is electronically transmitted to the designated receiver. Transmitting the selected virtual item comprises transmitting the customized virtual item through an internet protocol.

According to the designated voice, color and/or the gesture, the virtual item makes sounds and/or gestures on the website of the receiver. For example, the virtual item such as an electronic version of the toy pet 100 can play the sounds and make the gestures when the receiver click the icon or the icon shape toy pet 100 displayed on the social networking website. If the receiver is a mobile phone user, the mobile phone user can hear and/or see the selected sounds, colors and/or movements of the virtual pet toy on the mobile phone screen.

The virtual icon such as, for example, the toy pet 100 icon or a whopper icon of Burger King® can play the sounds and make the gestures. For example, once the whooper virtual icon is clicked on the Burger King commercial internet website, the whopper virtual icon plays designated sounds and makes certain gestures. Such a commercial virtual icon can be delivered to a consumer's website.

The receiver of the physical item can be designated when the receiver of the virtual item is designated. In an exemplary embodiment of the present invention, the physical item receiver can be the same person as the virtual item receiver. Designating the receiver of the physical item such as the toy pet 100 comprises designating a physical address of the receiver. The physical address can be a home address or an office address of the receiver. The manufactured physical item is transmitted to the designated receiver having the physical address. Transmitting the produced physical item to the designated receiver comprises delivering the produced physical item in person to the physical address of the receiver.

Although exemplary embodiments have been described herein with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A method of transmitting a virtual item and a physical item to a receiver, the method comprising:
customizing a virtual item in a designated internet website;
producing a physical item corresponding to the customized virtual item;
designating a receiver of the virtual item;
designating the receiver of the physical item;
transmitting the customized virtual item to the designated receiver; and
transmitting the physical item to the designated receiver,
wherein the physical item has a same three-dimensional appearance with the virtual item displayed on a two-dimensional screen of the designated internet website.

2. The method of claim 1, wherein customizing the virtual item comprises: inputting a voice message to the virtual item.

3. The method of claim 2, wherein the physical item has the same voice message with the voice message stored in the virtual item.

4. The method of claim 1, wherein customizing the virtual item comprises at least one of:
selecting a color of the virtual item;
selecting a face expression of the virtual item; and
selecting a predetermined sound of the virtual item.

5. The method of claim 4, wherein customizing the virtual item further comprises: changing a frequency of a generation of the predetermined sound of the virtual item.

6. The method of claim 2, wherein inputting the voice message to the virtual item comprises: recording the voice message of a user.

7. The method of claim 2, wherein inputting the voice message of the virtual item comprises:
typing a text message into the designated website; and
converting the text message into the voice message.

8. The method of claim 4, wherein the predetermined sound is at least one of flatulence, yelling, laughing, yawning, sighing and giggling.

9. The method of claim 1, wherein producing the physical item corresponding to the virtual item is performed with a generation of the virtual item.

10. The method of claim 1, wherein designating the receiver of the virtual item comprises: designating an email address of the receiver.

11. The method of claim 1, wherein designating receiver of the virtual item comprises: designating an http server of the receiver.

12. The method of claim 1, wherein designating the receiver of the physical item comprises: designating a physical address of the receiver.

13. The method of claim 1, wherein transmitting the selected virtual item comprises: transmitting the customized virtual item through an internet protocol.

14. The method of claim 11, wherein transmitting the produced physical item to the designated receiver comprises: delivering the produced physical item in person to the physical address of the receiver.

15. The method of claim 1, wherein the virtual item is displayed as an internet icon.

16. The method of claim 1, wherein the physical item is at least one of a toy, a computer mouse, a speaker, a flash memory stick, a key chain, an MP3 player, a cell phone and a necklace.

17. The method of claim 15, wherein the voice message of the virtual item is played by clicking the icon.

18. The method of claim 2, wherein the voice message stored in the physical item is played by touching the physical item, squeezing the physical item, or pressing a button disposed on the physical item.

19. The method of claim 4, wherein the predetermined sound is played randomly.

20. An electronic circuit for use in a pet toy, comprising:
a microprocessor;
a sensing circuit including a capacitor and a foil electrode, the foil electrode sensing an increase of electronic charges and the capacitor transmitting a first signal to the microprocessor based on the increased electronic charges;
a main circuit including the microprocessor and a memory unit storing data for use in the microprocessor, the microprocessor producing a second signal to generate a sound and a third signal to generate a vibration, when the electric charge value is above a certain level and remains constant for a pre-determined time, the microprocessor sends the second signal to a sound generating circuit to play sounds;
a sound generating circuit including a speaker, the sound generating circuit receiving the second signal from the microprocessor for generating the sound through the speaker; and
a motion generating circuit including a vibrating motor, the motion generating circuit receiving the third signal from the microprocessor for generating the vibration,
wherein the second signal is sent to the sound generating circuit from the microprocessor to play a sound played with a probability of 1/N through the speaker, wherein the N refers to number of sounds.

21. The electronic circuit of claim 20, wherein the sound includes at least one of a sound of comfort, a news report, stock information, a weather report and a fashion guru.

22. The electronic circuit of claim 20, wherein the sound includes at least one of sigh, flatulence, yawn, giggle, and laugh.

23. The electronic circuit of claim 20, further comprising a data receiving circuit including at least one of a USB connector, a Wi-Fi connection, and a Bluetooth connection.

24. The electronic circuit of claim 20, wherein the sound generating circuit further comprises a next track, a previous track and a play/pause switch.

25. The electronic circuit of claim 24, wherein the microprocessor sends the second signal to the next track or the previous track to play different sounds each time when a random time is reached.

26. The electronic circuit of claim 20, wherein the electronic circuit is disposed inside a body of the pet toy.

27. The electronic circuit of claim 20, wherein the foil electrode senses the increase of the electric charges when the body of the pet toy receives an external impact.

28. The electronic circuit of claim 20, wherein a light emitting diode (LED) is disposed on an outer surface of the body of the pet toy.

29. The electronic circuit of claim 28, wherein the light emitting diode (LED) emits light when the pet toy is turned on and blinks when the pet plays a sound.

30. A method of generating a sound or a vibration for use in a toy pet, the method comprising:
inputting a voice message into the toy pet;
sensing a touch from a user of the toy pet;
determining a value of electronic charges increased by the touch of the user;
generating a first sound when the value of the electric charges is above a pre-determined level and remains constant for a pre-determined time; and
generating a second sound or vibration when the toy pet is not touched by a user and when a random time is reached.

31. The method of claim 30, wherein the first sound and the second sound are played with a probability of 1/N, wherein the N refers to the number of sounds.
